(19) United States
(12) Patent Application Publication
(10) Pub. No.: US 2014/0344002 A1
(43) Pub. Date: Nov. 20, 2014

(54) METHOD AND APPARATUS FOR ABNORMAL EVENT RESPONSE PLANNING

(71) Applicant: NUCLEAR SAFETY ASSOCIATES, INC., Charlotte, NC (US)

(72) Inventor: James Masterlark, River Falls, WI (US)

(73) Assignee: NUCLEAR SAFETY ASSOCIATES, INC., Charlotte, NC (US)

(21) Appl. No.: 13/896,016

(22) Filed: May 16, 2013

(51) Int. Cl. G06Q 10/06

(52) U.S. Cl. CPC G06Q 10/06315
USPC 705/7.25

(57) ABSTRACT

Systems, methods, apparatuses, and computer readable media are disclosed for providing an event response plan. A method is provided for providing an event response plan via a planning interface. The method may include receiving facility infrastructure data. The facility infrastructure data may define a set of facility logic for generating an event response plan for a particular facility. The method may also include receiving facility situational data. The facility situational data may indicate a status of at least one abnormal event occurring at the particular facility. The method may also include deriving, using a processor, an event response plan using at least the facility infrastructure data and the facility situational data, and providing the event response plan via a planning interface.

### FIELD

Embodiments discussed herein are related to abnormal event planning and, more particularly, to systems, methods, apparatuses, computer readable media and other means for generating abnormal event response plans.

### BACKGROUND

As technology has advanced, humanity is increasingly reliant on facilities that pose some risk in operation. Although power plants, factories, ports, and other industrial facilities provide a great benefit to society, such facilities typically require dangerous chemicals and equipment in order to provide these benefits. As a result, an accident or natural disaster at one of these facilities may endanger employees and other individuals located nearby. In order to mitigate these risks, facility operators may develop response pre-plans to respond to such occurrences. When an abnormal event occurs, these pre-plans may be used to develop attack plans for addressing the specific circumstances surrounding the emergency condition. A number of deficiencies and problems associated with generation of such event response plans are identified herein. Through applied effort, ingenuity, and innovation, exemplary solutions to many of these identified problems are embodied by the present invention, which is described in detail below.

### BRIEF SUMMARY

Systems, methods, apparatuses, and computer readable media are disclosed for generating abnormal event response plans.

Embodiments may include a computer-implemented method for event response planning. The method may include receiving facility infrastructure data. The facility infrastructure data may define a set of facility logic for generating an event response plan for a particular facility. The method may also include receiving facility situational data. The facility situational data may indicate a status of at least one abnormal event occurring at the particular facility. The method may further include deriving, using a processor, an event response plan using at least the facility infrastructure data and the facility situational data. The event response plan may be derived by determining one or more entry points for directing an event response team to a particular location, selecting at least one of the one or more entry points based on the facility situational data, and indicating the selected at least one entry point in the event response plan. The method may also include providing the event response plan via a planning interface. In some embodiments, a type of the at least one abnormal event is at least one of a fire, a chemical spill, a seismic event, a weather event, a terrorist attack, or a tsunami. The event response plan may be further derived based on the type of the at least one abnormal event. The event response plan further may include recommended equipment for event response personnel, and the recommended equipment may be determined based on the type of the at least one abnormal event. At least a portion of the facility situational data may be received from one or more facility sensors. In some embodiments, at least one of the one or more facility sensors may be a smoke detector, a heat detector, a camera, a radiation detector, an intrusion alarm, or a wind sensor.

The method may also include generating a log of the facility situational data and at least one activity performed in response to the abnormal event. In yet further embodiments, the event response plan includes a list of procedures for responding to the abnormal event, and the list of procedures may be modified based on the facility situational data. The method may further include receiving personnel information for emergency response personnel responding to the abnormal event, and deriving the event response plan at least in part based on the personnel information. The personnel information may include at least one of equipment assigned to the event response personnel, a location of the event response personnel, or a training status of the event response personnel. The event response plan may include at least one of an event pre-plan or an event attack plan. In some embodiments, the method may include identifying at least one equipment component, determining at least one isolation protocol for the identified equipment component, and determining, using the facility situational data, whether the at least one isolation protocol may be safely enacted. The method may also include in response to determining that the at least one isolation protocol cannot be safely enacted based on the facility situational data, determining a contingency isolation protocol, and incorporating the contingency isolation protocol into the emergency plan. In additional embodiments, the method may further include in response to determining that the at least one isolation protocol can be safely enacted based on the facility situational data, incorporating the at least one isolation protocol into the event response plan. Deriving the event response plan may include determining at least one of a response personnel assembly area, evacuation route, or a staging location. Deriving the event response plan may include modifying the event response plan based on a location of one or more equipment storage locations.

Embodiments may also include computer readable storage media. An example non-transitory computer readable storage medium may include that, when executed by a processor, cause the processor to configure an apparatus. The instructions may cause the processor to configure the apparatus to at least receive facility infrastructure data. The facility infrastructure data may define a set of facility logic for generating an event response plan for a particular facility. The instructions may further cause the processor to configure the apparatus to receive facility situational data. The facility situational data may indicate a status of at least one abnormal event occurring at the particular facility, and the instructions may cause the processor to derive an event response plan using at least the facility infrastructure data and the facility situational data. The event response plan may be derived by at least determining one or more entry points for directing an event response team to a particular location, selecting at least one of the one or more entry points based on the facility situational data, and indicating the selected at least one entry point in the event response plan. The instructions may further cause the processor to configure the apparatus to provide the event response plan via a planning interface. In some embodiments, the instructions also cause the processor to configure the apparatus to generate a log of the facility situational data and at least one activity performed in response to the abnormal event.

In some embodiments the instructions further cause the processor to configure the apparatus to receive personnel information for emergency response personnel responding to the abnormal event, and to derive the event response plan at least in part based on the personnel information. In yet further embodiments, the instructions may further cause the processor to configure the apparatus to identify at least one equipment component, determine at least one isolation protocol for the identified equipment component, and to determine, using the facility situational data, whether the at least one isolation protocol may be safely enacted. The instructions may further cause the processor to configure the apparatus to, in response to determining that the at least one isolation protocol cannot be safely enacted based on the facility situational data, determine a contingency isolation protocol, and to incorporate the contingency isolation protocol into the emergency plan. In some embodiments, the instructions further cause the processor to configure the apparatus to, in response to determining that the at least one isolation protocol can be safely enacted based on the facility situational data, incorporate the at least one isolation protocol into the event response plan.

Embodiments may also include an apparatus for event response planning. The apparatus may include at least one processor and at least one memory for storing program instructions. When executed by the at least one processor, the program instructions may configure the apparatus to receive facility infrastructure data. The facility infrastructure data may define a set of facility logic for generating an event response plan for a particular facility. The program instructions may further configure the apparatus to receive facility situational data. The facility situational data may indicate a status of at least one abnormal event occurring at the particular facility. The program instructions may also configure the apparatus to derive an event response plan using at least the facility infrastructure data and the facility situational data. The event response plan may be derived by at least determining one or more entry points for directing an event response team to a particular location, selecting at least one of the one or more entry points based on the facility situational data, and indicating the selected at least one entry point in the event response plan. The apparatus may also be configured to provide the event response plan via a planning interface. In some embodiments, the program instructions further configure the apparatus to generate a log of the facility situational data and at least one activity performed in response to the abnormal event.

The program instructions may further configure the apparatus to receive personnel information for emergency response personnel responding to the abnormal event, and to derive the event response plan at least in part based on the personnel information. The program instructions may further configure the apparatus to identify at least one equipment component, determine at least one isolation protocol for the identified equipment component, and determine, using the facility situational data, whether the at least one isolation protocol may be safely enacted. The program instructions may further configure the apparatus to, in response to determining that the at least one isolation protocol cannot be safely enacted based on the facility situational data, determine a contingency isolation protocol, and to incorporate the contingency isolation protocol into the emergency plan. In some embodiments, the program instructions further configure the apparatus to, in response to determining that the at least one isolation protocol can be safely enacted based on the facility situational data, incorporate the at least one isolation protocol into the event response plan.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an exemplary interface for accessing a dynamic facility event response plan in accordance with some embodiments of the present invention;

FIG. 2 illustrates an exemplary interface for accessing a detailed view of a dynamic facility event response plan in accordance with some embodiments of the present invention;

FIG. 3 illustrates an exemplary interface for accessing a detailed view of a modified dynamic facility event response plan in accordance with some embodiments of the present invention;

FIGS. 4-9 provide flowcharts of some exemplary processes for generating, modifying, accessing, and/or interacting with an event response plan in accordance with some embodiments of the present invention; and

FIG. 10 illustrates a block diagram of components that may be included in devices for generating an event response plan in accordance with some embodiments of the present invention.

The present invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

### DETAILED DESCRIPTION

### Overview

Existing systems for providing abnormal event response plans may enable users to view static plans for responding to particular abnormal events. For example, a fire response pre-plan may instruct a response team to perform a particular set of actions depending upon the location of the fire, while an earthquake response pre-plan may direct the same response team to perform alternative actions. These pre-plans are typically static, with particular pre-plans being associated with particular emergencies equipment failures (e.g., a first plan to fight a fire in a first facility room, a second plan for fighting a fire in an alternative room), or other conditions. Existing techniques for generating event response plans may be inadequate due to the inability of such techniques to provide a viable response to dynamically changing emergency conditions or multiple simultaneous events, such as the disaster at the Fukushima Nuclear Plant that involved both a seismic event and a tsunami. In some examples, pre-generated pre-plans may not address a particular event and thus attempting to employ these plans may lead to a waste of valuable time attempting to rework the pre-plan to address the current emergency conditions. Furthermore, it would be advantageous to provide a dynamic event response plan to assist users with testing and verification of event response and attack procedures and to provide an efficient reference to such procedures when a disaster occurs.

For example, a fire at a nuclear power plant may involve multiple hazards that must be addressed by responders. Responders may need to prevent exposure to hazardous chemicals and dangerous levels of radiation while also avoiding damage to sensitive electrical equipment. The configuration of the particular facility and the emergency status of the location may have a dramatic impact on the optimal procedures for responding to the event. Example embodiments may provide these responders with a dynamic event attack plan that is responsive to the status of the particular site. Embodiments may further provide for a mechanism to certify event response plans, verify that a particular plan covers all possible contingencies, and provide logging to track the performance of emergency responders.

Embodiments may provide response personnel with displays, devices, and other interfaces that are configured to dynamically receive facility infrastructure data and facility situational data to give response personnel a real-time, dynamically updating view of a response to an abnormal event. For example, embodiments may include a mobile device capable of wirelessly receiving facility infrastructure data and facility situational data and updating an event response plan in real-time to assist emergency response personnel with developing and enacting an event response plan for a particular abnormal event. Embodiments may include a touch screen interface allowing users to easily and efficiently interact with a planning interface to facilitate these operations.

For the purpose of this application, the term “event response plan” or “abnormal event response plan” should be understood to refer to a set of protocols and/or instructions for responding to an abnormal event. Although some embodiments are presented herein with respect to the specific example of an emergency planning interface, it should be readily appreciated that the same or similar techniques could be applied to any abnormal event, including events that require response planning but which are not emergencies. For example, in addition to preparing event response plans for emergency conditions such as seismic events, tsunamis, fires, chemical spills, security events, and the like, embodiments may also be employed to develop and enact event response plans to non-emergent, but unexpected, abnormal, or unusual events. For example, while a disruption to a power grid due to damage to transmission lines or a sudden usage spike may not qualify as an emergency, embodiments may still function to assist with development of a response plan to mitigate negative impacts and remediate any damage or disruption caused by the event.

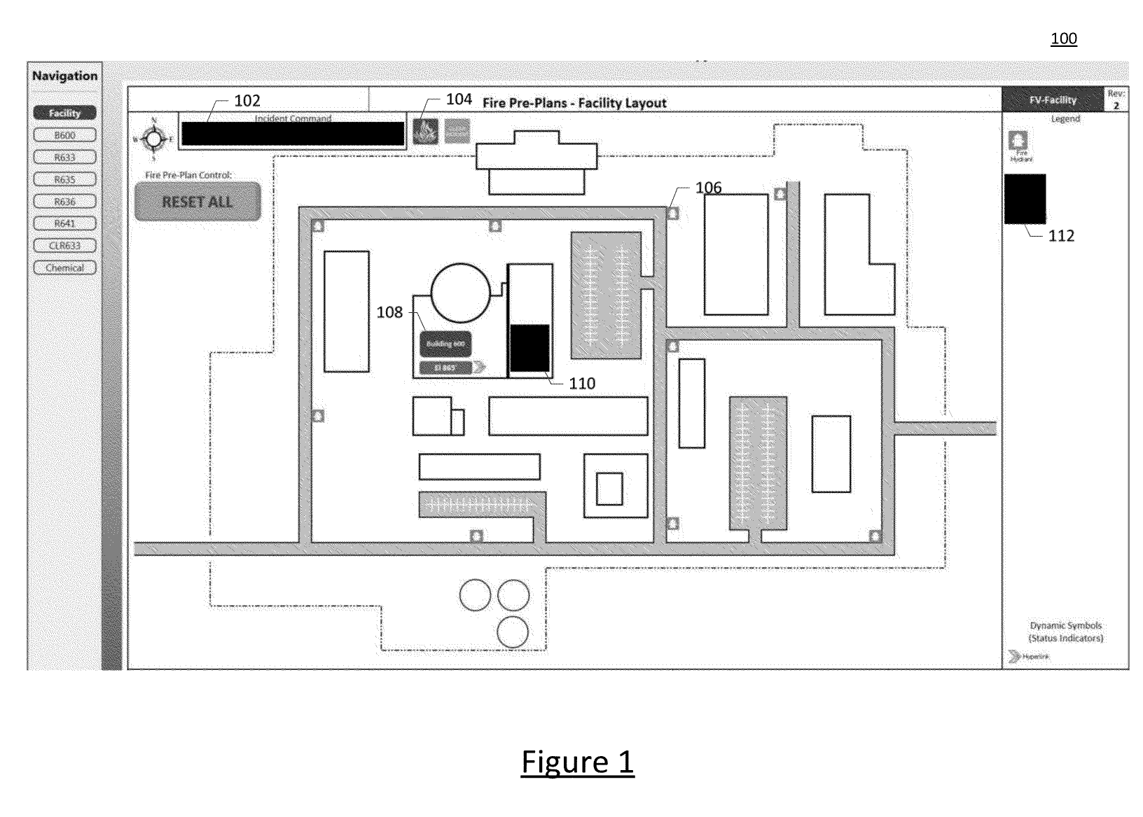

These event response plans may include one or more maps and checklists for informing a user of one or more protocols and/or instructions. In some embodiments, the event response plan may include a set of logic for determining elements of the one or more protocols and/or instructions. The event response plan may also include maps, facility equipment diagrams, and the like, for use by responders. The event response plan may include “pre-plans” derived in advance and “attack plans” that are developed for addressing specific conditions as they occur. Example embodiments of the event response plan, an interface for accessing the event response plan, and a device for providing the event response plan are described further below with respect to FIGS. 1-10.

The terms “situational status” and “facility situational data” should be understood to refer to information about the current status of the facility, such as data received from one or more facility sensors, the facility electrical system status, the facility mechanical system status, the status of response personnel (e.g., locations, training, equipment), and any other data relevant to the current status of the facility as related to the specific abnormal event for which the event response plan is intended to be executed. The situational status and facility situational data may be dynamic and provided based on facility sensors, manual input, or the like. The dynamic nature of the situational status and facility situational data is in contrast to facility infrastructure data, which includes facility data such as the location of facility structures and equipment. However, although the facility infrastructure data is described as static relative to the situational status and facility situational data, embodiments may provide for modification, updating, or correction of facility infrastructure data during interaction with a planning interface.

Embodiments of the present invention are directed to methods, systems, apparatuses, and computer readable storage media for generating, viewing, and modifying event response plans. Embodiments may provide for dynamic generation or modification of an event response plan based on data input by a user or received from one or more facility sensors. Embodiments of the present invention may provide for adjustment of one or more response protocols, instructions, checklists, or the like based on the received data. Embodiments may provide for automated capture of data from the facility sensors, such as by receiving data feeds from facility heat sensors, smoke detectors, carbon monoxide detectors, cameras, intrusion detection alarms, location sensors, or the like.

Embodiments of the present invention are illustrated in the appended figures and description below in relation to a fire emergency at a nuclear power plant. However, as will be apparent to one of ordinary skill in the art in view of this disclosure, the inventive concepts herein described are not limited to fire emergencies or nuclear power plants. Indeed, the concepts described herein may be applied to various other abnormal events. For example, these abnormal events may include emergency conditions including, without limitation, other emergencies such as seismic events, tsunamis, terrorist attacks, hurricanes, tornadoes, and the like. The concepts may also be applied for emergency planning for other industrial facilities such as ports, refineries, offshore oil rigs, factories, chemical processing plants and non-nuclear power plants, residential facilities such as apartment buildings, or neighborhoods, or any other structures that may benefit from development of an event response plan, such as stadiums, movie theaters, schools, or concert halls. In some example embodiments, event response plans may also take the form of evacuation routes, incident response planning for a geographical area and/or the like.

### Example Event Response Plan Interface

FIG. 1 illustrates an exemplary interface 100 for accessing a dynamic event response plan in accordance with some embodiments of the present invention. The interface 100 displays an image corresponding to a site plan of a particular facility, in this case, a power generation facility that includes a nuclear power plant. The site plan provides an interactive map of the facility for use in responding to an emergency condition, such as a fire. As described above, although much of the exemplary instant interface is described with respect to a fire emergency, the same or a similar interface could also be applied to other abnormal events. In some embodiments, the interface 100 may provide the capability to select a particular abnormal event, such as an emergency condition or conditions, and the interface 100 may be modified based on the selected abnormal event. For example, icons displayed in the interface may be altered if the emergency condition is a chemical spill as opposed to a fire, or the sensor input data may be altered for a radiation leak (e.g., input data from radiation sensors may be obtained or prioritized) as opposed to a fire (e.g., input data from smoke detectors or heat sensors may be prioritized). In some embodiments, the interface may automatically detect the type of abnormal event and configure itself appropriately (e.g., configured for a fire based on input from smoke detectors/heat sensors, configured for a seismic event based on input from an on-site seismograph counter, or configured for a radiation event based on input from an on-site Geiger counter).

The interface 100 may include a series of icons used to mark the position of events, equipment, and personnel relevant to the response to the abnormal event. In this example, the interface 100 includes a set of incident command icons 102 and a fire icon 104. The incident command icons 102 may include icons for the position of various response brigades, an emergency medical services triage location, fire trucks, command posts, and the like. The fire icon 104 may be used to mark the location of a fire. In some embodiments, the icons 102, 104 may be manually placed by a user, such as by dragging the icons from a menu of the interface. In other embodiments, one or more of the icons may be dynamically placed based on input received from one or more sensors. For example, members of a first emergency response brigade may be equipped with global positioning system (GPS) sensors for providing the interface 100 with their location, or a fire icon 104 may be placed at locations where smoke detectors or heat sensors indicate there may be a fire. In some examples, the incident command icons 102 may be indicative of a particular size or the particular capabilities of a unit. As such the movement of the icons 102 may result in a modification of a response plan.

The interface 100 may also include one or more facility icons 106. In the present example, the facility icon 106 indicates the presence of a fire hydrant. These icons may be associated with the site plan of the particular facility. In some embodiments, the appearance of the facility icons 106 may be adjustable. For example, the facility icon 106 may turn red if water pressure is not available at the particular fire hydrant indicated by the icon. In some embodiments, the interface 100 may provide the user with the capability to manually adjust the status of the facility icons 106 (e.g., selecting the icon to indicate it is disabled), while in other embodiments the icons may dynamically update based on data received from one or more sensors (e.g., sensors in the hydrant that detect the presence of water pressure and report as such to the interface 100).

In some embodiments, the interface 100 may also provide logging capabilities. The interface 100 may track the times and locations at which particular events occur, such as the placement of icons to indicate changes in the status of the emergency response process. For example, when a particular brigade arrives at a location and their icon is updated, the interface 100 may log the time and location with an event for the arrival of the brigade. The interface 100 may further include one or more placed icons 110.

In some example embodiments, the placement of the icons, such as icon 110, may trigger event logging and/or the initialization of timers. For example, the placement of icon 110 may be used to indicate that a fire has been detected in a particular structure. The “fire” icon (e.g., icon 110) may be associated, in some examples, with a timer such that the timer can track the amount of time since the placement of the icon in a particular location on the interface. In the present example, the icon was placed at the particular structure 1 hour, 30 minutes, and 43 seconds ago, thus indicating the start time and the duration of the fire at a given location.

As described above, the placed icon 110 may be placed manually, in which case the timer may initialize when the icon is placed, or the icon may be placed dynamically based on facility situational information, such as in response to receiving data from a facility smoke detector or heat sensor. Where the icon is placed dynamically, the timer may automatically initialize when the abnormal condition (e.g., activation of the smoke detector or heat sensor) is detected. The interface 100 may include a legend or sidebar for tracking each of the timers. For example, the interface 100 includes a legend that features a timer icon 112 for tracking the status of each timer initialized by the system. In some embodiments, this legend interface may be used to provide the user with the status of any initialized timers even if the user navigates away from the screen upon which the icon is placed. It should be appreciated that alternative timers may also be employed other than timers based on the detection of emergency conditions. For example, timers may be used to monitor the amount of time a particular brigade of response personnel have been in a structure, the remaining time backup generators will remain operational, or for any other event for which response personnel may wish to monitor an elapsed or remaining time.

Similarly, changes in the situational status of particular locations (e.g., fire detected, fire extinguished, equipment isolated) may also be logged. Logging operations may also occur at periodic intervals to take a snapshot of the situational response status. In some embodiments, the interface 100 may also provide log viewing and playback functionality, allowing a user to review the response to a particular incident using the tools and status monitoring windows provided by the interface 100.

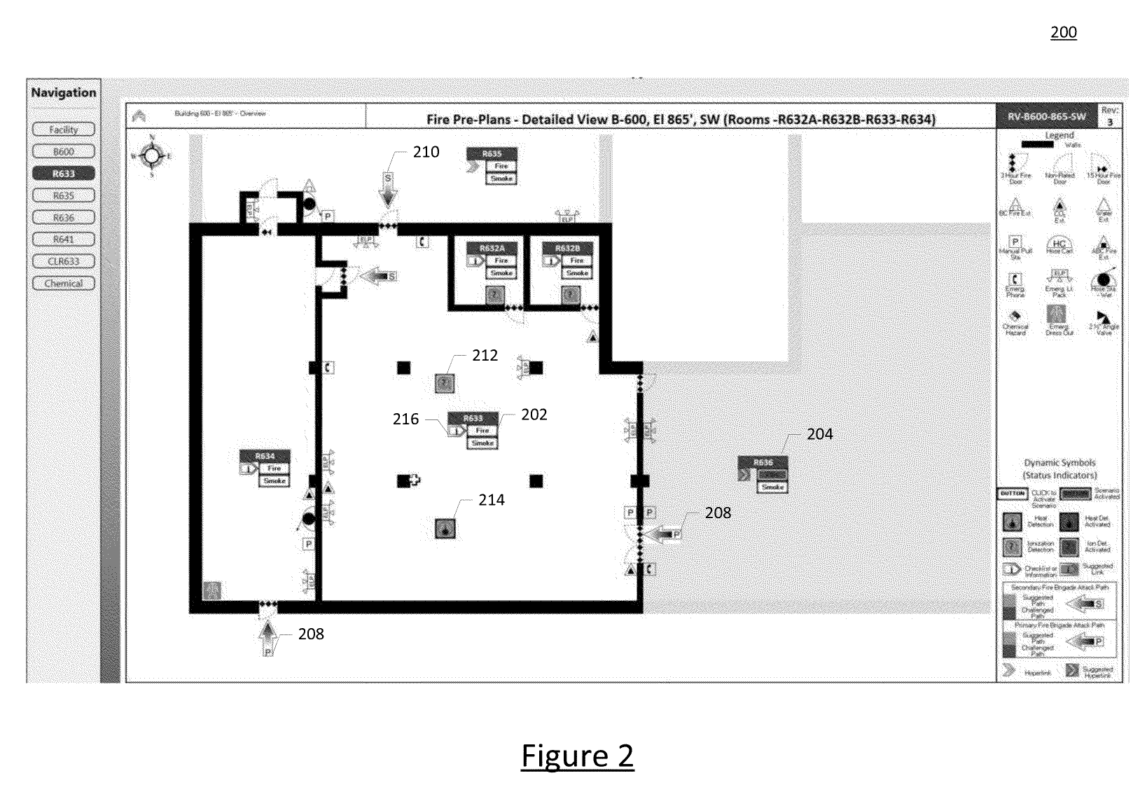

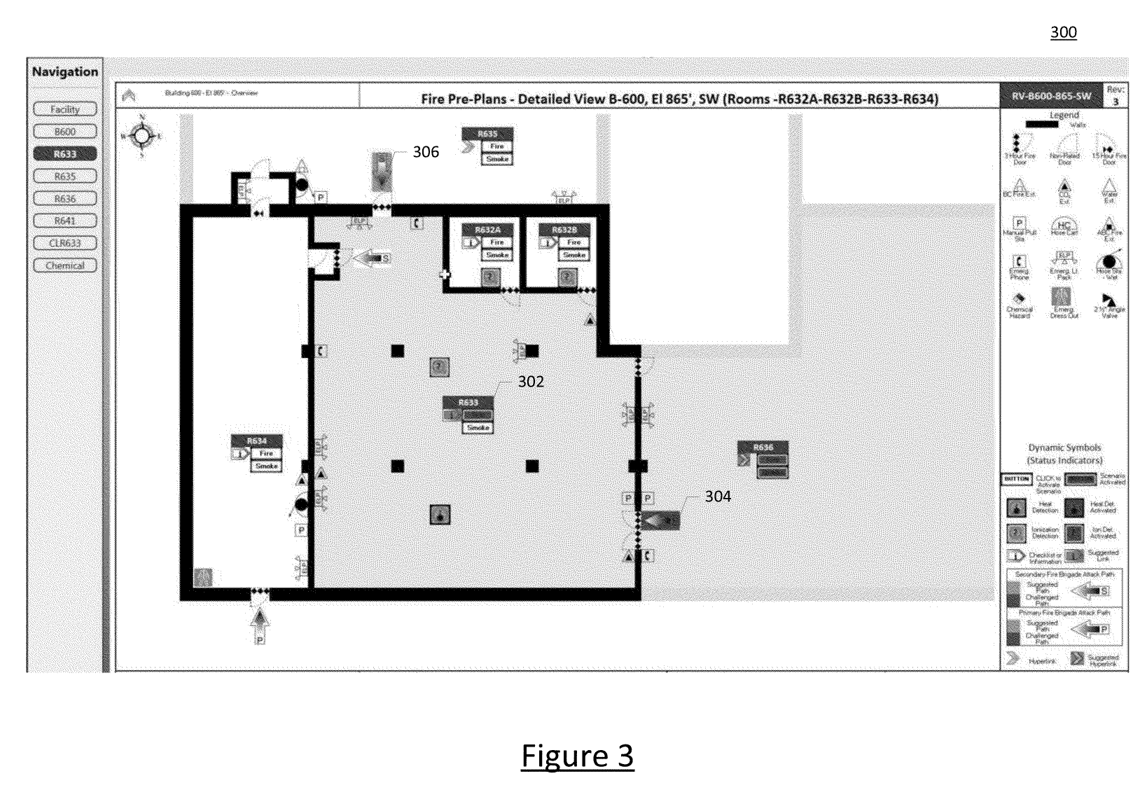

The interface 100 may further include one or more links 108. The links 108 may, upon selection, provide a more detailed view of an event response plan associated with an entity associated with the link. For example, the link 108 is associated with a particular structure and, upon selection of the link 108, the interface 100 may be altered to display a detailed view of an event response plan associated with the particular structure. An example of such a detailed view of a facility event response plan is described further below with respect to FIGS. 2 and 3.

FIG. 2 illustrates an exemplary interface 200 for accessing a detailed view of a dynamic event response plan in accordance with some embodiments of the present invention. The interface 200 depicts an event response plan for a particular structure, room, or set of rooms of the facility. As described above with respect to FIG. 1, the interface 200 may include a map or other representation of the selected structure within the facility. For example, the interface 200 may depict a detailed view of a structure associated with a link 108 as described above with respect to FIG. 1. Each room depicted in the interface may include a room menu. In the present example, the room labeled R633 is associated with the menu 202, and the room R636 is associated with the menu 204. Each of the menus 202, 204 may include interface controls for setting or viewing the situational status regarding their respective room. For example, the menus 202, 204 may indicate the presence of smoke or fire within the room. In some embodiments, the room menu may be dynamically populated based on sensor data received from facility sensors, such as smoke detectors or heat sensors. In the present example, these sensors are represented by a smoke detector icon 212 and a heat detector icon 214, respectively. The appearance of these icons may be adjusted to indicate their status. For example, if the presence of smoke or heat is detected, then the smoke detector icon 212 or the heat detector icon 214, respectively, may be marked as red. Upon detection of an emergency condition, the room menu may likewise be altered in appearance to reflect the situational status (e.g., the presence of smoke or fire).

Although the instant examples provided are related to the use of the interface 200 during an actual event, it should be readily apparent that such methods and techniques could also be used during training exercises, procedure testing and verification, and the like. In such circumstances, facility conditions may be manually input or simulated using test inputs to view and verify the expected impact of such events on the event response plan. In some embodiments, such inputs may be programmatically generated and applied to the interface 200 to detect possible errors or flaws in logic underlying generation of the event response plan.

In some embodiments, the menus 202, 204 may further include interface controls allowing a user to manually select a status for the room. For example, upon selecting a “smoke” or “fire” interface control, the respective room may be identified as containing smoke or fire for use in generation or modification of the event response plan. The menus 202, 204 may further include an icon 216 that, upon selection, provides the user with a detailed checklist and/or procedures for responding to the emergency based on the status of the particular room. For example, the checklist may include a set of procedures for safely powering down electrical devices within the room or for disposing of hazardous chemicals stored within the room. These procedures and instructions may be dynamically modified based on the status of the room and of other rooms. For example, the procedures may include a list of electrical equipment, along with locations of breakers in other rooms that may be disabled to electrically isolate the equipment listed in the checklist. These breaker locations may be dynamically changed based on the safety status of the other rooms in the facility within which the breakers are located. For example, if a nearest “upstream” breaker is located in a room in which a fire has been detected, the procedures may be modified to instead reference the next breaker in the hierarchy that is not located in a room with an emergency status.

In some embodiments, the interface 200 may provide an event response plan for the particular room. For example, the interface 200 may indicate one or more entry pathways for safely entering the room. These entry pathways may include primary pathways 208 and secondary pathways 210. These pathways may be dynamically modified based on the safety status of the room and adjacent rooms. An exemplary altered interface based on a change in entry pathway status is described further below with respect to FIG. 3.

FIG. 3 illustrates an exemplary interface 300 for accessing a detailed view of a modified dynamic event response plan in accordance with some embodiments of the present invention. As described above with respect to FIGS. 1 and 2, the interface 300 may be modified based on input provided to the interface 300. For example, a user may select one or more situational statuses from a menu 302 to indicate that certain conditions (e.g., an abnormal or atypical condition) are present. Alternatively or additionally, such status information can be dynamically updated based on sensor data, an alarming system, a facility management system and/or the like as is described herein.

In the present exemplary interface 300, the menu 302 associated with room R633 has been selected to indicate that a fire is present within the room. In response to selection of the “fire” status for room R633, possible entry points to the room have been highlighted. These entry points, the primary entry point 304 and the secondary entry point 306, may be highlighted based on whether each entry point is safe. In the present example, the primary entry point 304 for entry to room R633 requires traveling through room R636. However, room R636 has emergency status indicators of “smoke” and “fire”, so the primary entry point 304 has been highlighted as unsafe (e.g., highlighted in red). Since the primary entry point 304 is unsafe, the status of the secondary entry point 306 may be checked. Since the secondary entry point 306 is through a room without any emergency statuses (e.g., no fire or smoke), the secondary entry point 306 may be highlighted as safe since the secondary entry point 306 is safe but the primary entry point 304 is not. In this manner, the interface 300 may be dynamically updated as the emergency status of the facility changes. For example, if fire is detected in room R635, then the entry point may be further modified to reflect the fact that the secondary entry point 306 is also unsafe.

### Example Event Response Plan Generation and Modification

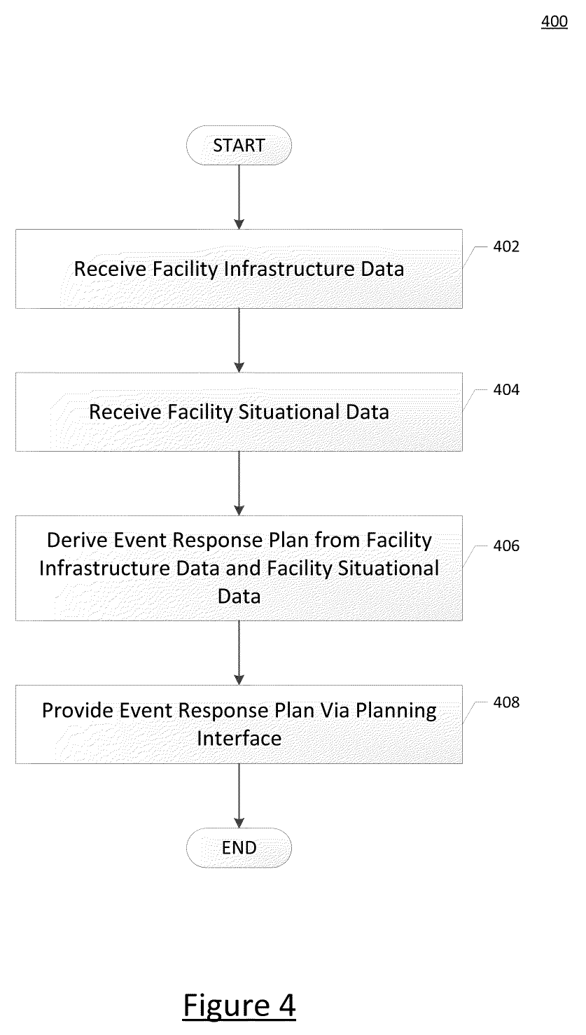

FIGS. 4-9 provide flowcharts of some exemplary processes for generating, modifying, and/or interacting with an event response plan in accordance with some embodiments of the present invention. These figures illustrate examples of different operations that may be employed to generate, modify, and retrieve event response plans for a particular facility or structure.

FIG. 4 illustrates a flowchart of an exemplary process 400 for providing an event response plan in accordance with embodiments of the present invention. The process 400 may be employed to provide a user with a dynamic event response plan reflecting the emergency status of a particular facility.

At action 402, facility infrastructure data is received. In the present context, the term “facility infrastructure data” may include, but is not limited to, facility maps, schematics, blueprints, equipment diagrams, and the like that is used to populate a set of facility logic. The facility logic may include equipment dependencies, prioritization of points of entry to particular rooms, information on the location of hazardous chemicals, information on the various sensors with which the facility is equipped, and the like. The facility logic may be automatically derived based on the provided data (e.g., blueprints may be scanned in and portions of the facility logic may be generated based on room demarcations identified within the blueprints), or the facility logic may be manually generated.

In some embodiments, the facility infrastructure data may be obtained through interfacing with one or more facility systems. For example, the facility may maintain an inventory of hazardous chemicals stored at the facility, along with locations of those chemicals. In some embodiments, this inventory may be interfaced with to obtain accurate inventory levels of the hazardous chemicals to assist with generation of the event response plan. The facility infrastructure data may also include the location of personnel “dress out” locations, locations where the personnel can go to obtain equipment used for emergency response.

At action 404, facility situational data is received. As described above, the facility situational data may include information that is manually input via a planning interface (e.g., based on user selection of controls within the interface, such as a “smoke” or “fire” icon), or the facility situational data may be dynamically received from one or more facility sensors. In some embodiments, the relationships between particular sensors and the facility situational data may be defined within the facility infrastructure data (e.g., the facility infrastructure data may indicate the type and location of the various sensors within the facility).

At action 406, the facility infrastructure data and the facility situational status data is used to derive or otherwise enact an event response plan for the facility. As described above with respect to FIGS. 1-3, the event response plan may apply the current facility situational status to a set of event planning logic for the facility to identify a response to the particular situational status. For example, the derived event response plan may include instructions for how personnel should enter rooms in which fire has been detected, which equipment personnel should disable in order to isolate sensitive equipment in areas in which the fire is occurring, which gear “dress out” location personnel should go to in order to obtain hazardous material handling equipment, or how personnel should dispose of hazardous chemicals in areas in which the fire is occurring.

In some cases, derivation of the event response plan may also include determination and/or analysis of additional data gathered in response to the particular emergency status of the facility. For example, a wind speed and direction as determined from a wind sensor may be used to estimate the distance that harmful fumes may travel, chemical dispersion analysis techniques may be employed to determine a duration that a particular room with a chemical spill will remain unsafe for entry, or timing data may be used to evaluate the amount of time a particular brigade can remain in a hazardous environment or the amount of time before a particular structure is likely to suffer structural damage.

At action 408, the event response plan may be provided via a planning interface, such as the interfaces 100, 200, 300 described above with respect to FIGS. 1, 2, and 3, respectively. Providing the event response plan may include modifying these interfaces, such as by altering the visual display to reflect different points of entry, or changing the visual representation of particular rooms to reflect the situational status of the room. In some embodiments, providing the event response plan may also include modifying checklists or procedures for responding to the event for a particular room, for a particular equipment component, or for the facility as a whole. For example, a checklist for a room may be updated with the most efficient procedure for isolating electrical power for equipment within the room. In this manner, the situational response plan may be dynamically updated as changes are received to the facility situational status.

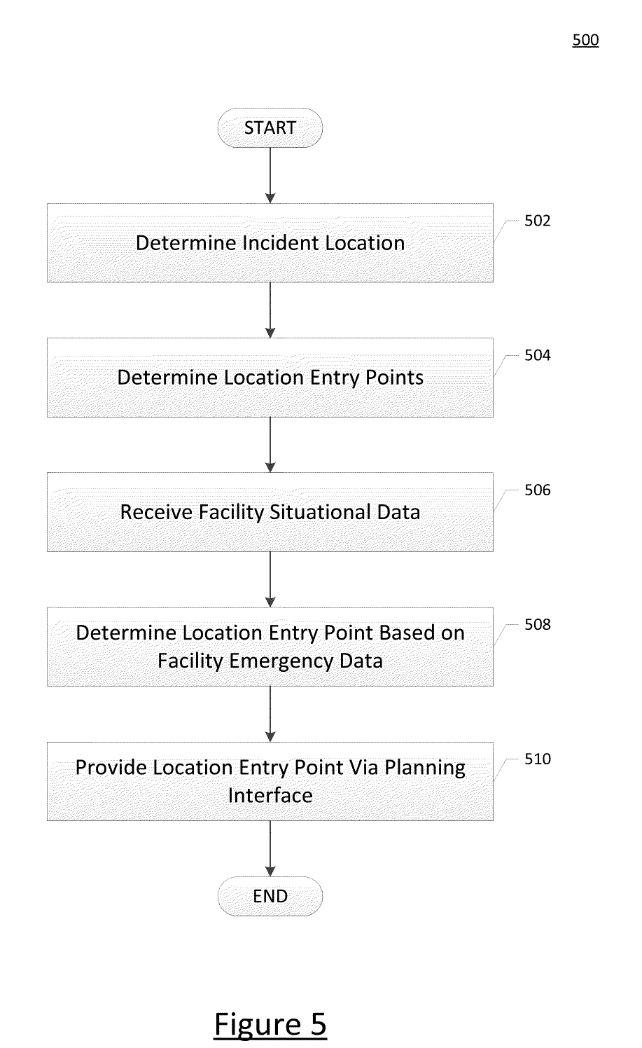

FIG. 5 depicts an example process 500 for determining a point of entry to a location in accordance with embodiments of the present invention. As described above with respect to FIGS. 1-4, the process of generating and/or updating an event response plan may include determining an optimal point of entry for a particular room. This point of entry may be determined based on the status of the particular room, the status of any rooms through which the point of entry passes, and various other factors such as the distance between the point of entry and emergency response personnel, the proximity of the point of entry with equipment “dress out” locations, or the like. The process 500 may thus be employed to dynamically identify an optimal point of entry to a particular location based on the particular circumstances of the emergency.

At action 502, an incident location is determined. The incident location may be determined based on a manual selection of a location (e.g., by selecting a link associated with a particular room, as described with respect to FIGS. 1-3), or the incident location may be determined automatically based on received sensor data (e.g., heat sensors may be employed to identify the location of a fire).

At action 504, the process 500 determines the available entry points for the location determined at action 502. These entry points may be defined within facility logic associated with a set of facility infrastructure data. For example, at the time the facility infrastructure data is received, each room may be associated with one or more entry points. In some embodiments, these entry points include a priority order, indicating a preferred order for entering the location if other factors are equal.

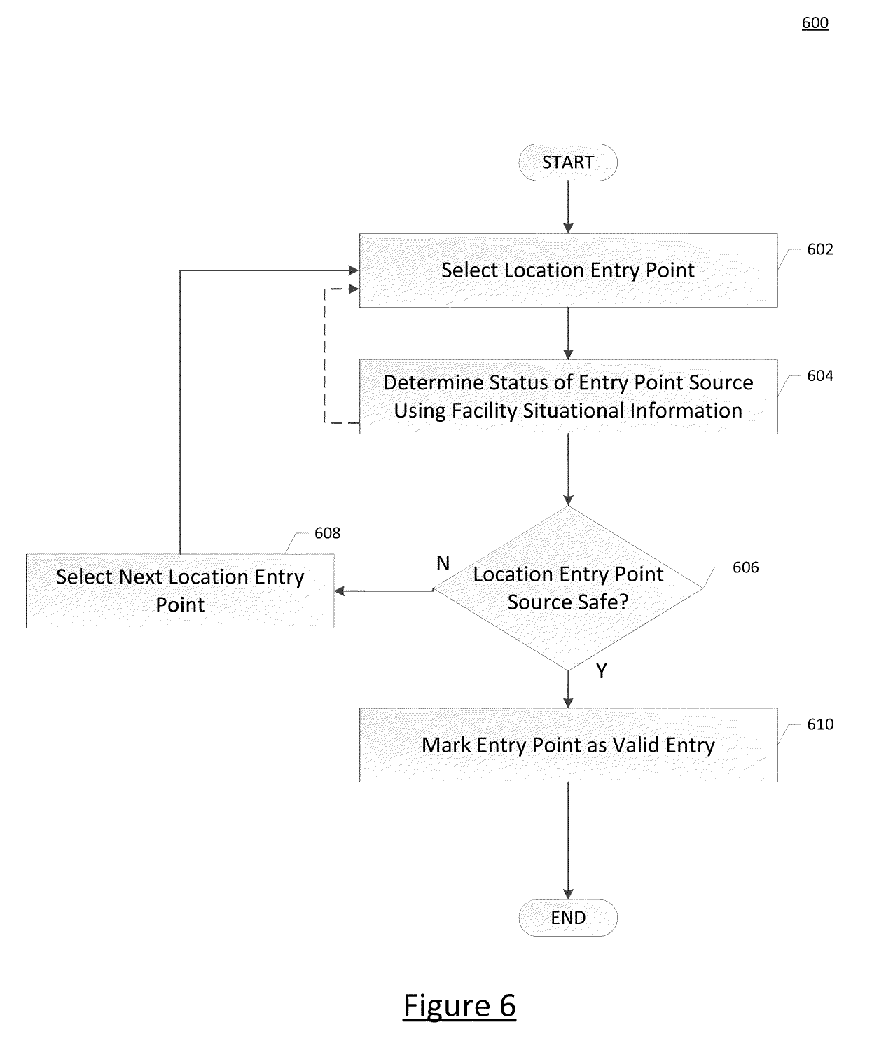

At action 506, situational status data is received for the facility. As described above, this situational status data may include data that is manually input to a planning interface, or data that is automatically received via one or more sensors. At action 508, the location entry point may be determined based on the situational status data. For example, the location entry point may be determined such that the location entry point avoids sending personnel through locations that have an active emergency status (e.g., the process 500 may prioritize entry through rooms that do not have a status of “smoke” or “fire”). An example method for selecting a location entry point is described further below with respect to FIG. 6.

At action 508, the determined location entry point may be provided via the planning interface. As described above with respect to FIG. 3, one or more location entry points may be added to or highlighted in the planning interface to reflect the optimal entry point based on the received situational status data.

FIG. 6 depicts an example process 600 for selecting an entry point based on received facility situational status data in accordance with embodiments of the present invention. As described above, embodiments may have the capability to identify a particular entry point for a location that minimizes the risk to response personnel or otherwise provides an improved event response plan for addressing an event at a particular location.

At action 602, a location entry point is selected for analysis. As described above with respect to FIGS. 1-5, the locations within a particular facility may be associated with a set of logic that enumerates one or more entry points for the particular location. These entry points may be associated with a priority, such that location entry points are examined in priority order, with the highest priority first. The entry point priority may be determined based on various criteria. For example, the entry point priority may be user generated, or dynamically determined based on an overall plan of attack for addressing the event (e.g., to ensure that response teams are able to systematically proceed through the facility as they address the abnormal event). In the event the entry point with the highest priority is unavailable, the next entry point with the next highest priority may be considered, and so on. The process proceeds to action 604 after selecting the location entry point.

At action 604, the status of the particular entry point source location (e.g., the location through which personnel must pass to enter the location through the selected entry point), is determined using facility emergency data. Determination of the entry point source location status may include consideration of a variety of factors related to the entry point source location, including, without limitation, the presence of hazardous conditions within the current location and proximate to the location entry point, the presence of hazardous conditions within the source location the type of emergency equipment possessed by the response personnel, the wind speed and direction, and the like. In some embodiments, the step of determining the status of the entry point source location may further include determining the status of the entry points to the source location of the selected entry point. In such cases, the process 600 may proceed recursively back to action 602 to consider the status of the entry point sources to the source location of the initially selected entry point. After determining the status of the location entry point, the process proceeds to action 606.

At action 606, the process 600 branches depending upon whether the source location is determined to be safe. If the source location is determined to be safe, the process 600 proceeds to action 610, where the selected location entry point is marked as a valid entry point. Otherwise, the process 600 proceeds to action 608 where the next location entry point is selected for consideration. The process 600 may then repeat for the next location entry point.

It should be readily appreciated that the depicted process may also include additional steps for evaluating location entry points. For example, the process 600 may employ scoring logic for selection between multiple entry points with the same or similar characteristics and priorities. In some embodiments, the process 600 may also include tie-breaking logic for selecting an entry point where two entry points have the same or a similar score. In yet further embodiments, the process 600 may include different logic or weighting characteristics for evaluating entry points based on the particular facility or type of emergency condition. For example, wind speed and direction characteristics may receive a higher weighting in determining an entry point for a chemical spill emergency condition with hazardous fumes, while the presence of a radiation leak proximate to a particular entry point may receive a lower weighting if emergency response personnel is equipped with radiation shielded hazmat suits. In other examples, weighting may be assigned based on a determined danger or critical area that is to be isolated, a determined piece of critical infrastructure or the like. For example, the weighting may be assigned such that critical infrastructure components are protected (e.g., backup generators, combustible chemicals) prior to secondary elements of the infrastructure (e.g., inert chemical storage or employee restrooms).

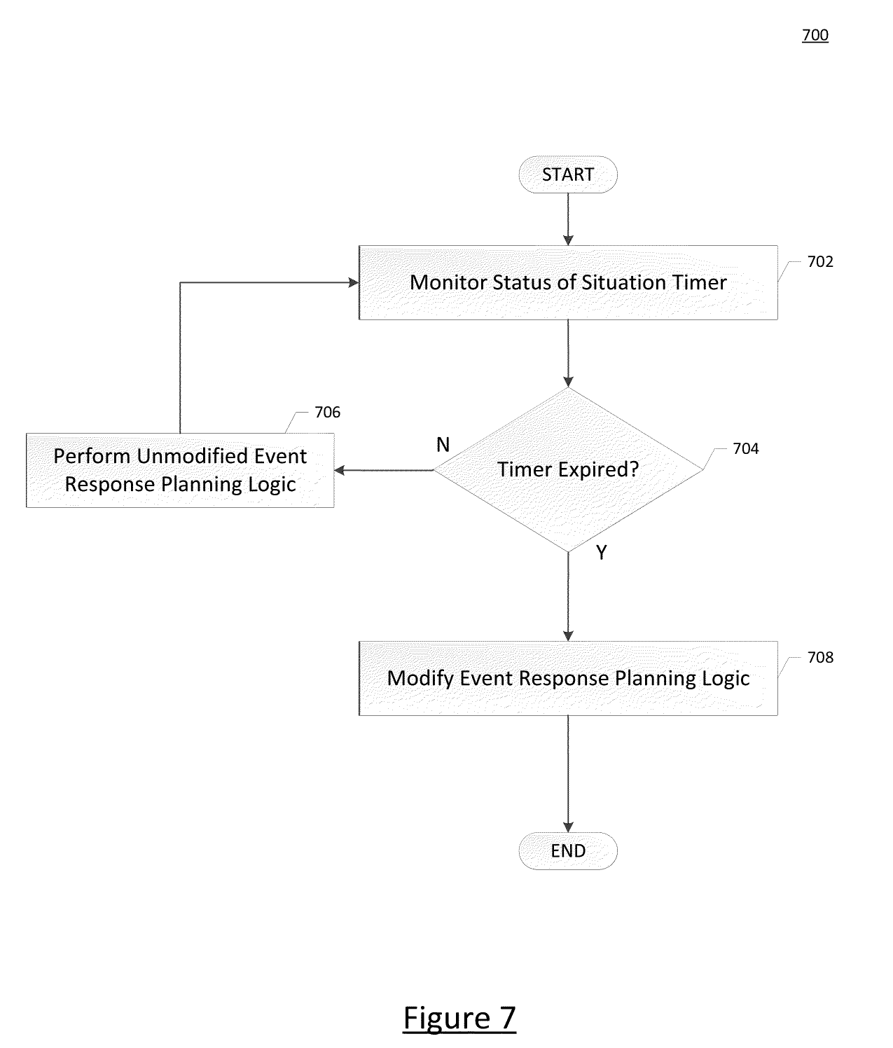

FIG. 7 depicts an example process 700 for incorporating situation timers into generation of an event response plan in accordance with embodiments of the present invention. As described above with respect to FIGS. 1-3, the planning interface may be employed to establish timers for various situational occurrences, such as detection of an abnormal condition (e.g., smoke, a fire, a chemical spill, a power outage) or the elapsed time since a particular response protocol was enacted (e.g., dispatch of an emergency response brigade to a particular location). The process 700 illustrates how these timers may be employed to dynamically update an event response plan.

At action 702, the status of a particular situation timer is monitored. As described above with respect to FIG. 1, timers may be initialized manually (e.g., a user selecting or placing a timer icon), or dynamically (e.g., initializing a “fire” timer in response to receiving data from a heat detector indicating a fire is occurring). The process 700 may automatically monitor these timers to update the event response plan as appropriate.

At action 704, the process 700 branches depending upon whether an expiration condition has occurred for the timer. The expiration condition may be related to the type of timer and/or may be manually configured by the user. In some embodiments, timers may be associated with multiple expiration conditions. For example, a timer may provide a notification to a user at period intervals, such as every 5 minutes, every 30 minutes, every hour, or the like. Different expiration conditions may be associated with different changes in logic. For example, a timer that tracks the amount of time response personnel have been fighting a fire in a particular location with self-contained breathing apparatus equipment may periodically update the user with how much oxygen the brigade has remaining. In some examples, the updates may be provided with increasingly noticeable notifications as time goes on. If an expiration condition has not occurred, the process 700 proceeds to action 706, where the unmodified event response logic is executed. In other words, if the timer has not expired, then the event logic should not be modified on account of the timer. If an expiration condition has occurred, the method proceeds to action 708.

At action 708, the process 700 updates the event response logic based on the particular timer that has expired. As described above, expiration of a timer event may have different effects based on the particular timer. For example, certain timers may trigger notifications to the user. Other timers may impact a particular procedure checklist as part of the event response plan. For example, if a fire condition has existed in a structure for greater than a certain period of time, then the event response logic may determine that the structure has likely received structural damage. If structural damage is assumed, then possible entry points for developing an attack plan may be eliminated from the event response plan, such as roof entry points, due to the increased risk of a structural collapse endangering response personnel. Although specific examples with respect to brigade deployment timers and building structural damage timers have been given, it should be readily appreciated that various other changes could be made to the event response logic based on timers implemented according to the process 700.

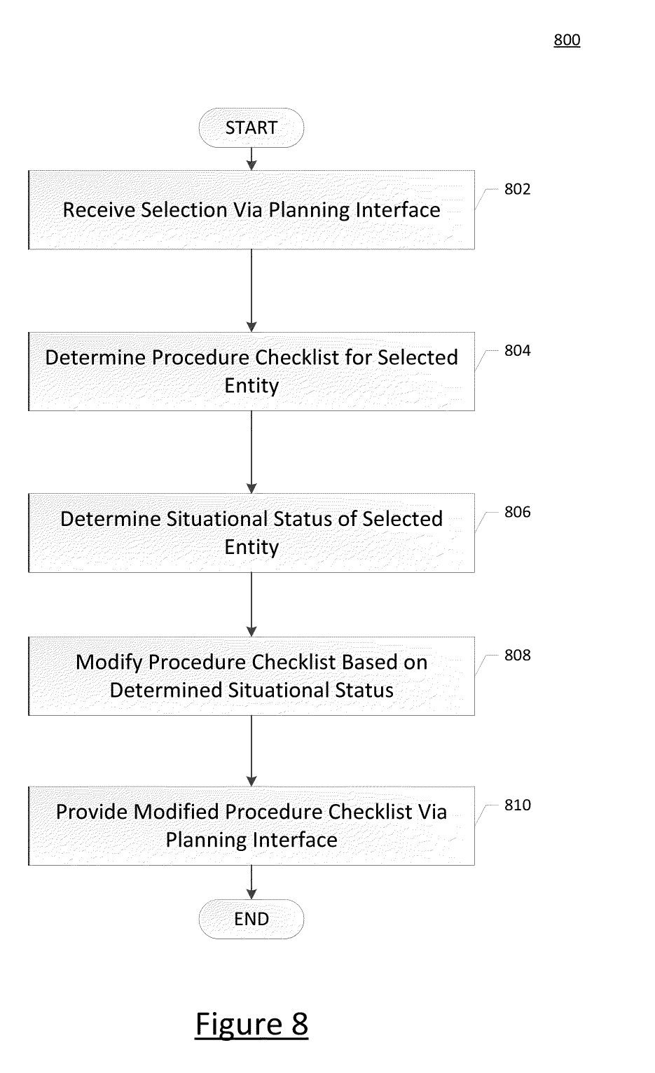

FIG. 8 depicts an example process 800 for providing a procedure checklist in accordance with embodiments of the present invention. As described above with respect to FIGS. 1-3, a planning interface may provide links to dynamic procedure checklists containing abnormal event response procedures for locations and equipment within the facility. The process 800 illustrates how these checklists may be dynamically modified based on situational status data received for the facility.

At action 802, a particular entity is selected via a planning interface. As described above with respect to FIGS. 1-3, a location may be selected using a link provided in a facility display. For example, the link may be associated with a particular structure within the facility. Additionally or alternatively, the selected entity may also relate to other elements of the event response process. For example, the selection may relate to particular equipment selected from an equipment dependency diagram. It should be readily appreciated that the selection operation could apply to any entity with which a particular set of event response procedures are associated.

At action 804, a procedure checklist is determined for the selected entity. The procedure checklist may include a set of procedures for responding an abnormal event involving the selected entity. For example, a procedure checklist for a particular room or location may include instructions for safely isolating equipment within the room and removing any potential hazards present in the room such as combustible chemicals. A procedure checklist for a particular equipment component may include instructions for safely disabling or isolating the equipment from any damage. However, although these checklists include various procedures that may be used in an event response involving the selected entity, these checklists may be further configurable based on the situational status of the facility. The process 800 may thus proceed to action 806 to obtain facility situational information used for configuration of the checklist.

At action 806, the situational status of the selected entity is determined. As described above, the situational status may involve the status of any element in the facility that pertains to the selected entity. For example, the situational status may include the status of locations that are associated with equipment that should be disabled as part of the checklist procedures for the selected entity, the status of equipment used in checklist procedures involving the selected entity, or the like. This situational status information may be used to configure the procedure checklist at action 808.

At action 808, the procedure checklist may be modified based on the situational status information. This modification may take into account the status of other entities within the system and their situational status. For example, if the checklist for a particular location includes instructions to disable a particular equipment component in second location, but the another location has an unsafe status (e.g., a fire), then the checklist may be modified to instead reference a third location further “upstream” than the second location to allow for a safe shutoff of the impacted equipment. Modifications to the checklist in this manner may be made in accordance with logic established for the facility based on facility infrastructure data, such as equipment dependencies. The procedure checklist may also be dynamically modified in response to the situational status in other ways based on similar logic. For example, the checklist may indicate that a particular set of equipment is required based on the type of event, such as recommending the use of hazardous material suits in the case of a chemical spill or the use of self-contained breathing apparatuses upon detection of smoke.

At action 810, the modified checklist may be provided via a planning interface, ensuring that responders are provided with accurate data that reflects the situational status of the facility.

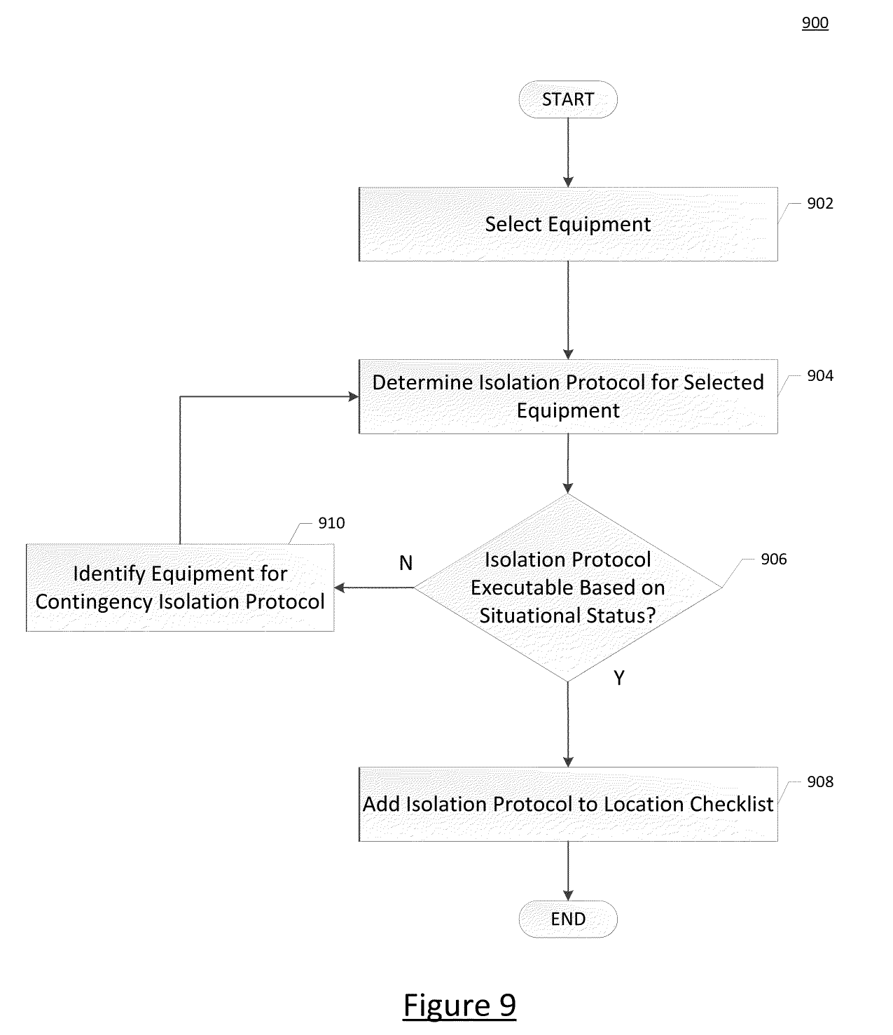

FIG. 9 depicts an example process 900 for determining an element of a procedure checklist in accordance with embodiments of the present invention. As described above with respect to FIGS. 1-3 and 8, a planning interface may provide links to dynamic procedure checklists containing event response procedures for locations and equipment within the facility. These event response procedures may be dynamically determined based on situational status data. The process 900 illustrates an example embodiment for determining equipment isolation protocol for a particular equipment component based on the situational status data. For the purposes of the present example, the term “isolation protocol” refers to a set of steps and/or procedures used to ensure that equipment is safely disabled. For example, an isolation protocol may include disabling of an electrical power source or removing a fuel source for the equipment. Isolation of the equipment may ensure the safety of both response personnel, such as in circumstances where operational equipment poses a health or safety risk to response personnel, and of the equipment, such as in circumstances where event response protocols may damage operation equipment (e.g., the use of fire hoses around operational electrical equipment). The process 900 illustrates how elements of these checklists may be dynamically determined based on situational status data received for the facility.

At action 902, equipment is selected. The equipment may be selected based on input received from a user, or the equipment may be selected automatically as part of generation or modification of an event response plan. For example, a user may select a particular location via a planning interface, and the equipment associated with the selected location may automatically be selected by the interface. Alternatively, the user may select a particular equipment component, such as from a site equipment inventory or equipment dependency list. In some embodiments, the planning interface may provide such an equipment inventory or equipment dependency list, with interface controls for viewing, accessing, and selecting various equipment components associated with the facility. For example, the equipment dependency list may include an electrical diagram, showing the electrical couplings between equipment components such as cooling systems, pumps, valves, generators, circuit breakers, and the like. The planning interface may allow the user to select individual equipment components from such an interface to view the procedures for addressing an abnormal event involving the selected equipment. In some embodiments, equipment may be selected based on a facility situational status, such that equipment components associated with facility emergency conditions are automatically selected for determination of an isolation protocol (e.g., automatic determination of an isolation protocol for equipment in a room in which a fire has been detected).

At action 904, an isolation protocol is determined for the selected equipment. As described above, the isolation protocol may include a series of steps, actions, or instructions for disabling or otherwise ensuring the selected equipment is in proper condition for allowing execution of an emergency plan. Isolation of a particular equipment component may include disabling of electrical power, water pressure, input valves, fuel sources, or any other components that may cause the equipment to enter a disabled or powered down state. As such, these isolation protocols may require the manipulation or interaction with other equipment components located throughout the facility. In order to ensure that these actions may be safely performed, the situational status of the facility may be used to determine if the equipment necessary to enact the isolation protocol is safely accessible.

At action 906, the situational status of the facility may be used to determine whether the isolation protocol is safely executable by examining the situational status of the equipment identified within the isolation protocol. For example, if a fire exists in a room that contains a breaker box necessary to isolate the selected equipment, then it may not be safe to cut power at that particular breaker box. As such, if the process 900 determines that the isolation protocol cannot be safely executed, a contingency isolation protocol may be determined at action 908. If the isolation protocol may be safely enacted (e.g., all locations necessary to perform the isolation protocol are accessible and not hazardous), then the process 900 may proceed to action 910 where the isolation protocol is added to a checklist for the selected equipment.

At action 908, a contingency isolation protocol may be determined if the original isolation protocol cannot be safely executed. The contingency isolation protocol may include an alternate method of performing one or more steps of the original isolation protocol. For example, if, as described above, a breaker box is inaccessible due to a fire, then a breaker box further “upstream” between the selected equipment and the power source may be identified for isolation, as removing power from the upstream breaker box should also have the effect of disabling power to the downstream breaker box, and thus the originally selected equipment. Although the instant example is given with respect to electrical power, it should be appreciated that similar techniques could be applied to disabling other equipment capabilities, such as disabling a fuel supply or water pressure where a particular fuel source or valve is otherwise inaccessible.

Once a contingency isolation plan has been developed, the process 900 may return to action 904 to determine whether the contingency isolation plan may be safely enacted. The process loop of actions 904, 906, and 908 may continue until a valid isolation plan is determined for the originally selected equipment. In some embodiments, the process loop may exit after determining that no further contingency isolation protocols are possible. In some embodiments, if all contingency isolation protocols have been determined to be unsafe, a safest remaining alternative may be selected, even if the isolation protocol is associated with some sort of emergency condition. For example, if all but one equipment component in a dependency chain is associated with a detected fire and a smoke hazard, and the remaining equipment protocol is only experiencing a smoke hazard but not a detected fire, then the remaining equipment protocol may be identified as part of the isolation protocol for the selected equipment. In some embodiments, equipment that is identified as part of an isolation protocol but located in an environment experiencing an emergency condition may be identified as such in a checklist for the location to indicate the danger associated with enacting the isolation protocol.

Although the instant example is described with reference to an equipment isolation protocol, similar techniques may also be employed for other procedure checklists. For example, a similar process may be used for identifying an auxiliary power source for a particular equipment component, and the process may identify whether a series of auxiliary power sources are located in safe environments before populating a set of procedures to be used for establishing a backup power source for the selected equipment. As another example, security procedures for responding to a detected intrusion may be modified based on where the intrusion was detected and which areas of the facility are detected as compromised. Various additional or alternative protocols and procedures may also benefit from the use of methods similar to the process 900, as should be readily apparent given the needs of the facility for establishing response plans for various emergency conditions.

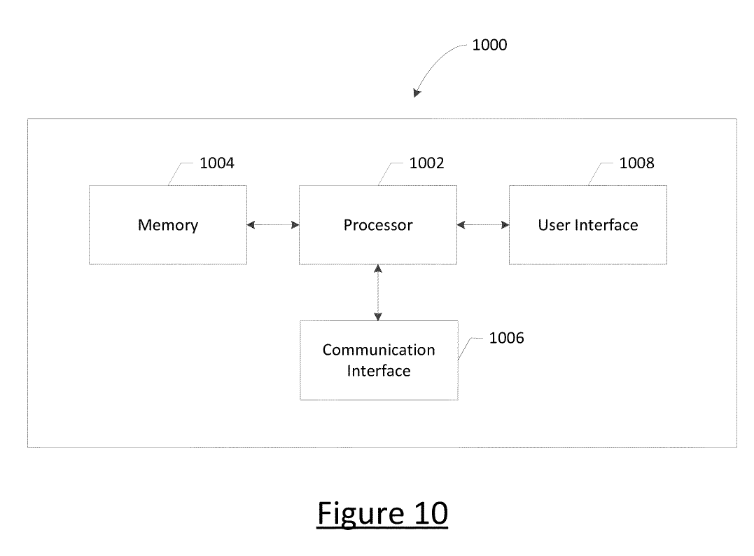

FIG. 10 illustrates a block diagram of components that may be included in an apparatus 1000 for generating an event response plan in accordance with some embodiments of the present invention. The apparatus 1000 may comprise one or more processors, such as a processor 1002, one or more memories, such as a memory 1004, communication circuitry 1006, and a user interface 91008. The processor 1002 can be, for example, a microprocessor that is configured to execute software instructions and/or other types of code portions for carrying out defined steps, some of which are discussed herein, such as the flowcharts described above with respect to FIGS. 4-9. The processor 1002 may communicate internally using data bus, for example, which may be used to convey data, including program instructions, between the processor 1002 and the memory 1004.

The memory 1004 may include one or more non-transitory storage media such as, for example, volatile and/or non-volatile memory that may be either fixed or removable. The memory 1004 may be configured to store information, data, applications, instructions or the like for enabling the apparatus 1000 to carry out various functions in accordance with example embodiments of the present invention. For example, the memory could be configured to buffer input data for processing by the processor 1002. Additionally or alternatively, the memory could be configured to store instructions for execution by the processor 1002. The memory 1004 can be considered primary memory and be included in, for example, RAM or other forms of volatile storage which retain its contents only during operation, and/or the memory 1004 may be included in non-volatile storage, such as ROM, EPROM, EEPROM, FLASH, or other types of storage that retain the memory contents independent of the power state of the apparatus 1000. The memory 1004 could also be included in a secondary storage device, such as external disk storage, that stores large amounts of data. In some embodiments, the disk storage may communicate with the processor 1002 using an input/output component via a data bus or other routing component. The secondary memory may include a hard disk, compact disk, DVD, memory card, disk storage on a remote computing node (e.g., a networked storage node or a digital download server) or any other type of mass storage type known to those skilled in the art.

In some embodiments, the processor 1002 may be configured to communicate with external communication networks and devices using the communications circuitry 1006, and may use a variety of interfaces such as data communication oriented protocols, including X.25, ISDN, DSL, among others. The communications circuitry 1006 may also incorporate a modem for interfacing and communicating with a standard telephone line, an Ethernet interface, cable system, and/or any other type of communications system. Additionally, the processor 1002 may communicate via a wireless interface that is operatively connected to the communications circuitry 1006 for communicating wirelessly with other devices, using for example, one of the IEEE 802.11 protocols, 802.15 protocol (including Bluetooth, ZigBee, and others), a cellular protocol (Advanced Mobile Phone Service or “AMPS”), Personal Communication Services (PCS), or a standard 3G wireless telecommunications protocol, such as CDMA2000 1x EV-DO, GPRS, W-CDMA, LTE, and/or any other protocol.

The apparatus 1000 may include a user interface 91008 that may, in turn, be in communication with the processor 1002 to provide output to the user and to receive input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., the memory 1004, and/or the like). In some embodiments, the user interface 1008 may be configured to provide an emergency planning interface as described above with respect to FIGS. 1-9.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A computer-implemented method for event response planning comprising:
receiving facility infrastructure data, the facility infrastructure data defining a set of facility logic for generating an event response plan for a particular facility;
receiving facility situational data, the facility situational data indicating a status of at least one abnormal event occurring at the particular facility;
deriving, using a processor, an event response plan using at least the facility infrastructure data and the facility situational data by at least:
determining one or more entry points for directing an event response team to a particular location;
selecting at least one of the one or more entry points based on the facility situational data; and
indicating the selected at least one entry point in the event response plan; and
providing the event response plan via a planning interface.

2. The method of claim 1, wherein a type of the at least one abnormal event is at least one of a fire, a chemical spill, a seismic event, a weather event, a terrorist attack, or a tsunami.

3. The method of claim 2, wherein the event response plan is further derived based on the type of the at least one abnormal event.

4. The method of claim 3, wherein the event response plan further comprises recommended equipment for event response personnel, and wherein the recommended equipment is determined based on the type of the at least one abnormal event.

5. The method of claim 1, wherein at least a portion of the facility situational data is received from one or more facility sensors.

6. The method of claim 5, wherein at least one of the one or more facility sensors is a smoke detector, a heat detector, a camera, a radiation detector, an intrusion alarm, or a wind sensor.

7. The method of claim 1, further comprising generating a log of the facility situational data and at least one activity performed in response to the abnormal event.

8. The method of claim 1, wherein the event response plan comprises a list of procedures for responding to the abnormal event, and wherein the list of procedures is modified based on the facility situational data.

9. The method of claim 1, further comprising:
receiving personnel information for emergency response personnel responding to the abnormal event; and
deriving the event response plan at least in part based on the personnel information.

10. The method of claim 9, wherein the personnel information comprises at least one of equipment assigned to the event response personnel, a location of the event response personnel, or a training status of the event response personnel.

11. The method of claim 1, wherein the event response plan comprises at least one of an event pre-plan or an event attack plan.

12. The method of claim 1, further comprising:
identifying at least one equipment component;
determining at least one isolation protocol for the identified equipment component; and
determining, using the facility situational data, whether the at least one isolation protocol may be safely enacted.

13. The method of claim 12, further comprising:
in response to determining that the at least one isolation protocol cannot be safely enacted based on the facility situational data, determining a contingency isolation protocol; and
incorporating the contingency isolation protocol into the emergency plan.

14. The method of claim 12, further comprising, in response to determining that the at least one isolation protocol can be safely enacted based on the facility situational data, incorporating the at least one isolation protocol into the event response plan.

15. The method of claim 1, wherein deriving the event response plan further comprises determining at least one of a response personnel assembly area, evacuation route, or a staging location.

16. The method of claim 1, wherein deriving the event response plan further comprises modifying the event response plan based on a location of one or more equipment storage locations.

17. A non-transitory computer readable storage medium comprising instructions that, when executed by a processor, cause the processor to configure an apparatus to at least:
receive facility infrastructure data, the facility infrastructure data defining a set of facility logic for generating an event response plan for a particular facility;
receive facility situational data, the facility situational data indicating a status of at least one abnormal event occurring at the particular facility;
derive an event response plan using at least the facility infrastructure data and the facility situational data by at least:
determining one or more entry points for directing an event response team to a particular location;
selecting at least one of the one or more entry points based on the facility situational data; and
indicating the selected at least one entry point in the event response plan; and
provide the event response plan via a planning interface.

18. The computer readable storage medium of claim 17, wherein a type of the at least one abnormal event is at least one of a fire, a chemical spill, a seismic event, a weather event, a terrorist attack, or a tsunami.

19. The computer readable storage medium of claim 18, wherein the event response plan is further derived based on the type of the abnormal event.

20. The computer readable storage medium of claim 19, wherein the event response plan further comprises recommended equipment for event response personnel, and wherein the recommended equipment is determined based on the type of the at least one abnormal event.

21. The computer readable storage medium of claim 20, wherein at least a portion of the facility situational data is received from one or more facility sensors.

22. The computer readable storage medium of claim 21, wherein at least one of the one or more facility sensors is a smoke detector, a heat detector, a camera, a radiation detector, an intrusion alarm, or a wind sensor.

23. The computer readable storage medium of claim 17, wherein the instructions further cause the processor to configure the apparatus to generate a log of the facility situational data and at least one activity performed in response to the abnormal event.

24. The computer readable storage medium of claim 17, wherein the event response plan comprises a list of procedures for responding to the abnormal event, and wherein the list of procedures is modified based on the facility situational data.

25. The computer readable storage medium of claim 17, wherein the instructions further cause the processor to configure the apparatus to:
receive personnel information for emergency response personnel responding to the abnormal event; and
derive the event response plan at least in part based on the personnel information.

26. The computer readable storage medium of claim 25, wherein the personnel information comprises at least one of equipment assigned to the event response personnel, a location of the event response personnel, or a training status of the event response personnel.

27. The computer readable storage medium of claim 17, wherein the event response plan comprises at least one of an event pre-plan or an event attack plan.

28. The computer readable storage medium of claim 17, wherein the instructions further cause the processor to configure the apparatus to:
identify at least one equipment component;
determine at least one isolation protocol for the identified equipment component; and
determine, using the facility situational data, whether the at least one isolation protocol may be safely enacted.

29. The computer readable storage medium of claim 28, wherein the instructions further cause the processor to configure the apparatus to:
in response to determining that the at least one isolation protocol cannot be safely enacted based on the facility situational data, determine a contingency isolation protocol; and
incorporate the contingency isolation protocol into the emergency plan.

30. The computer readable storage medium of claim 28, wherein the instructions further cause the processor to configure the apparatus to, in response to determining that the at least one isolation protocol can be safely enacted based on the facility situational data, incorporate the at least one isolation protocol into the event response plan.

31. The computer readable storage medium of claim 17, wherein deriving the event response plan further comprises determining at least one of a response personnel assembly area, evacuation route, or a staging location.

32. The computer readable storage medium of claim 17, wherein deriving the event response plan further comprises modifying the event response plan based on a location of one or more equipment storage locations.

33. An apparatus for event response planning, the apparatus comprising at least one processor and at least one memory for storing program instructions which, when executed by the at least one processor, configure the apparatus to:
receive facility infrastructure data, the facility infrastructure data defining a set of facility logic for generating an event response plan for a particular facility;
receive facility situational data, the facility situational data indicating a status of at least one abnormal event occurring at the particular facility;
derive an event response plan using at least the facility infrastructure data and the facility situational data by at least:
determining one or more entry points for directing an event response team to a particular location;
selecting at least one of the one or more entry points based on the facility situational data; and
indicating the selected at least one entry point in the event response plan; and
provide the event response plan via a planning interface.

34. The apparatus of claim 33, wherein a type of the at least one abnormal event is at least one of a fire, a chemical spill, a seismic event, a weather event, a terrorist attack, or a tsunami.

35. The apparatus of claim 34, wherein the event response plan is further derived based on the type of the abnormal event.

36. The apparatus of claim 35, wherein the event response plan further comprises recommended equipment for event response personnel, and wherein the recommended equipment is determined based on the type of the at least one abnormal event.

37. The apparatus of claim 33, wherein at least a portion of the facility situational data is received from one or more facility sensors.

38. The apparatus of claim 37, wherein at least one of the one or more facility sensors is a smoke detector, a heat detector, a camera, a radiation detector, an intrusion alarm, or a wind sensor.

39. The apparatus of claim 33, wherein the program instructions further configure the apparatus to generate a log of the facility situational data and at least one activity performed in response to the abnormal event.

40. The apparatus of claim 33, wherein the event response plan comprises a list of procedures for responding to the abnormal event, and wherein the list of procedures is modified based on the facility situational data.

41. The apparatus of claim 33, wherein the program instructions further configure the apparatus to:
receive personnel information for emergency response personnel responding to the abnormal event; and
derive the event response plan at least in part based on the personnel information.

42. The apparatus of claim 41, wherein the personnel information comprises at least one of equipment assigned to the event response personnel, a location of the event response personnel, or a training status of the event response personnel.

43. The apparatus of claim 33, wherein the event response plan comprises at least one of an event pre-plan or an event attack plan.

44. The apparatus of claim 33, wherein the program instructions further configure the apparatus to:
identify at least one equipment component;
determine at least one isolation protocol for the identified equipment component; and
determine, using the facility situational data, whether the at least one isolation protocol may be safely enacted.

45. The apparatus of claim 44, wherein the program instructions further configure the apparatus to:
in response to determining that the at least one isolation protocol cannot be safely enacted based on the facility situational data, determine a contingency isolation protocol; and
incorporate the contingency isolation protocol into the emergency plan.

46. The apparatus of claim 44, wherein the program instructions further configure the apparatus to, in response to determining that the at least one isolation protocol can be safely enacted based on the facility situational data, incorporate the at least one isolation protocol into the event response plan.

47. The apparatus of claim 33, wherein deriving the event response plan further comprises determining at least one of a response personnel assembly area, evacuation route, or a staging location.

48. The apparatus of claim 33, wherein deriving the event response plan further comprises modifying the event response plan based on a location of one or more equipment storage locations.
